(19) United States
(12) Patent Application Publication
(10) Pub. No.: US 2025/0026161 A1
(43) Pub. Date: Jan. 23, 2025

(54) METHOD FOR FORMING A PIVOTAL CONNECTION BETWEEN A TOWING VEHICLE AND A TRAILER, STATE ASCERTAINING ASSEMBLY, AND VEHICLE

(71) Applicant: ZF CV SYSTEMS GLOBAL GMBH, Bern (CH)

(72) Inventor: Janik RICKE, Uetze (DE)

(21) Appl. No.: 18/713,214

(22) PCT Filed: Nov. 1, 2022
(86) PCT No.: PCT/EP2022/080440

§ 371 Date: May 24, 2024

(30) Foreign Application Priority Data
Nov. 25, 2021 (DE) 10 2021 130 865.8

(51) Int. Cl. B60D 1/36; B60D 1/01; B60D 1/62

(52) U.S. Cl. CPC B60D 1/36; B60D 1/015; B60D 1/62

(57) ABSTRACT

A method for configuring a pivotable connection between a towing vehicle and a trailer by way of a trailer coupling, wherein configured in a locked state of the trailer coupling is a pivotable connection between a towing vehicle-proximal coupling element on the towing vehicle and a trailer-proximal coupling element on the trailer. The method includes establishing a coupling state of the trailer coupling by at least one item of status information once the towing vehicle has approached the trailer and causing a corrective movement such that the trailer and the towing vehicle move relative to one another. The corrective movement is caused when it cannot, or cannot plausibly, be established by the at least one item of status information whether the locked state of the trailer coupling is present.

### CROSS REFERENCE TO RELATED APPLICATIONS

This application is a U.S. National Phase application under 35 U.S.C. § 371 of International Application No. PCT/EP2022/080440, filed on Nov. 1, 2022, and claims benefit to German Patent Application No. DE 10 2021 130 865.8, filed on Nov. 25, 2021. The International Application was published in German on Jun. 1, 2023 as WO 2023/094122 A1 under PCT Article 21 (2).

### FIELD

The invention relates to a method for configuring a pivotable connection between a towing vehicle and a trailer by way of a trailer coupling, to a state determination assembly, and to a vehicle, in particular commercial vehicle.

### BACKGROUND

If a trailer is to be coupled to a towing vehicle by way of a trailer coupling, i.e. pivotably connected to said towing vehicle, the correct locking of the trailer coupling is to be verified, i.e. it is to be verified whether a locked state of the trailer coupling is also actually present. Already existing systems perform this using a camera, by establishing directly by means of the recorded image whether there is an existing connection. Furthermore known are position sensors, or locking sensors, by way of which it is verified whether the respective locking mechanism is closed.

In such a coupling procedure it can arise, above all in the case of drawbar trailers, that the clevis does not correctly close over of the coupling pin, and the islet therefore cannot be pivotably received on the drawbar. The reason for this may be that the vehicle has not been driven so as to be 100% straight in front of the drawbar trailer, that the height of the clevis does not precisely match, or that there is excessive wear in the clevis. Owing to the bracing arising herein, the coupling pin of the clevis can therefore not close correctly, and the control pin of the clevis cannot latch. In an analogous manner, issues of this type, or bracing of this type, can also arise in a semi-trailer with a fifth-wheel coupling, wherein the locking lever of the fifth-wheel plate in an analogous manner does not then latch correctly owing to bracing arising, for example.

Accordingly, the trailer coupling is not correctly closed in both cases, this creating a significant risk, in particular in fully automated vehicles in which no additional manual verification by a driver takes place, or the driver omits such a verification step.

For this purpose it is known from the prior art according to US 20200361397 A1 to determine the correct coupling of a trailer to a passenger motor vehicle by means of a camera, a LIDAR sensor, a radar sensor or an ultrasonic sensor. In a passenger motor vehicle, the respective sensor system herein can detect the coupling elements of the trailer coupling as described.

Described in DE 10 2020 103 099 A1 and DE 10 2020 102 667 A1 is in each case a coupling assistance system in which a camera is directed onto the coupling ball so as to control the approach procedure between the towing vehicle and the trailer. In the process, a vehicle course is determined, and the latter is subsequently followed. An assistance system for coupling a trailer to a towing vehicle is also described in DE 10 2014 003 953 A1, whereby a camera is used for this purpose, which determines the location of the eyelet on the drawbar of the trailer when reversing. A trajectory along which the towing vehicle approaches the trailer is then determined therefrom, whereby no verification takes place as to whether the trailer coupling is in the locked state.

It is furthermore described in DE 10 2019 007 662 A1 how a towing vehicle and a trailer are adjusted to the correct height, wherein sensor signals of a camera, of a LIDAR sensor, of a radar sensor or of an ultrasonic sensor are resorted to for this purpose. Described in DE 10 2018 122 224 A1 is a monitoring unit for coupling a towing vehicle and a trailer, wherein the vehicle movement is monitored for this purpose. Items of information pertaining to the movement of the towing vehicle or of the trailer are evaluated by a sensor installation for this purpose. However, it is not verified whether correct coupling is performed.

It is furthermore described in EP 1 580 043 B1 that the clevis is monitored by a single sensor installation when coupling a drawbar trailer to the towing vehicle, a signal signalling the mechanical coupling state of the trailer being able to be generated by said sensor installation. Should correct coupling not be present, the brake of the towing vehicle and/or trailer are/is applied. Furthermore, locking indicators for a fifth-wheel plate by way of a sensor are described in EP 0 794 110 B1, EP 3 297 896 A1 and DE 60 207 502 T2, said sensor measuring when the locking mechanism is in a closed position. Determining a position of a sensor pin on the trailer coupling takes place in DE 10 2020 115 065 A1, in order to determine the coupling state.

Furthermore, an image sensor of a camera, which monitors the movement of a closure element assigned to the trailer coupling, is described in DE 10 2004 029 129 A1. If the closure element indicates that the trailer coupling is locked, the towing vehicle is braked. If a trailer coupling having a sensor for detecting the open state of the trailer coupling is used, the towing vehicle can also be braked when a locked state is determined by means of this sensor. Monitoring of a locking system is also described in EP 3 122 618 B1, wherein the vehicle is braked when inappropriate coupling is identified, so that the vehicle is not driven away with an open coupling.

It is also described in DE 20 2019 104 576 U1 how a vehicle can be driven correctly in front of a trailer. Furthermore illustrated in DE 10 2018 117 584 A1 is an automatic coupling system for the supply installations of the trailer, i.e. for transmitting compressed air and energy. Furthermore, locking displays for a driver's cab are known, for example from DE 34 37 690 A1.

Therefore, at best braking is initiated in order not to cause any damage and to enhance safety in the respective situation in the methods described, even when inappropriate coupling, or an unlocked state of the trailer coupling, is established. Other automated responses to an incorrectly locked trailer coupling are not provided in the prior art.

### SUMMARY

In an embodiment, the present disclosure provides a method for configuring a pivotable connection between a towing vehicle and a trailer by way of a trailer coupling, wherein configured in a locked state of the trailer coupling is a pivotable connection between a towing vehicle-proximal coupling element on the towing vehicle and a trailer-proximal coupling element on the trailer. The method comprises establishing a coupling state of the trailer coupling by at least one item of status information once the towing vehicle has approached the trailer and causing a corrective movement such that the trailer and the towing vehicle move relative to one another. The corrective movement is caused when it cannot, or cannot plausibly, be established by the at least one item of status information whether the locked state of the trailer coupling is present.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIGS. 1a and 1b show schematic views of a vehicle having different trailer couplings;

FIG. 2 shows a flow chart of a method for determining a coupling state of a trailer coupling; and

FIG. 3 shows a flow chart of a method according to an embodiment of the invention.

### DETAILED DESCRIPTION

In an embodiment, the invention specifies a method and a state determination assembly by way of which a pivotable connection between a towing vehicle and a trailer can be automatically configured as a function of a determined coupling state. A vehicle is also provided.

Accordingly, provided according to an embodiment of the invention is a method for configuring a pivotable connection between a towing vehicle and a trailer by way of a trailer coupling, wherein configured in a locked state of the trailer coupling is a pivotable connection between a towing vehicle-proximal coupling element on the towing vehicle and a trailer-proximal coupling element on the trailer, comprising at least the following steps:
establishing a coupling state of the trailer coupling by means of at least one item of status information from which the coupling state can be derived/deduced or which is associated in any way with the coupling state, wherein the coupling state is determined once the towing vehicle has approached the trailer, i.e. the actual approach procedure has been completed and the coupling elements are preferably already in contact or have contacted one another, so that the coupling state indicates whether or not a pivotable connection has been configured after the actual approach and coupling procedure; and
causing a corrective movement, or a correcting relative movement between the towing vehicle in the trailer, which is not a constituent part of the approach procedure in the context of the coupling procedure, in such a manner that the trailer and the towing vehicle move relative to one another, wherein the corrective movement is caused when it cannot, or at least not plausibly, be established by means of the at least one item of status information whether the locked state of the trailer coupling is present.

If, counter to expectations, the trailer coupling has therefore not moved to the locked state after the approach procedure, a potentially unexpected mutual positioning of the coupling elements present can advantageously be cancelled or eliminated by the corrective relative movement, or corrective movement, respectively. It is assumed here, for example, that it cannot, or not plausibly, be established by means of the at least one item of status information whether the locked state of the trailer coupling is present when the adjustment of a locked state of the trailer coupling is prevented or impossible, for example when the towing vehicle-proximal coupling element and the trailer-proximal coupling element are braced, or not correctly co-aligned, respectively. In this case, depending on the type of detection, an unlocked state can be identified, or else it is not plausibly established which coupling state is actually present. Such bracing or incorrect positioning can however be cancelled in a simple and reliable manner by the corrective movement, so that the locked state can nevertheless still be attained without having to carry out any complex verification.

It is preferably sufficient herein that the corrective movement is automatically caused in that the towing vehicle and/or the trailer are/is at least momentarily set in motion. Bracing can thus already be eliminated in that the two coupling elements are momentarily moved relative to one another, so that a coupling pin or a coupling claw can indeed still latch into the respective coupling element, should this have previously been prevented by the bracing, for example. Accordingly, a simple correction of the locked state, previously not attained, is possible by momentarily setting in motion the towing vehicle and/or of the trailer. It is assumed herein that it is only important to cause a corrective relative movement between the two vehicle parts (towing vehicle and trailer), or coupling elements, respectively, this being able to be performed either by a movement of the trailer or by a movement of the towing vehicle, or both.

It can preferably be provided here that the corrective movement is caused in that a towing vehicle functional unit disposed in the towing vehicle, and/or a trailer functional unit disposed in the trailer, are/is automatically actuated, for example by a state determination unit according to the present disclosure, or as a function of a control signal emitted by the state determination unit, wherein the towing vehicle functional unit is formed by at least one unit selected from the group comprising:
a towing vehicle drive system, a towing vehicle clutch/transmission unit having a towing vehicle clutch, which can preferably be a constituent part of the towing vehicle drive system, a towing vehicle brake system having at least one towing vehicle braking means, for example service brakes and/or parking brakes and/or permanent brakes, a towing vehicle level control system, a towing vehicle steering system for steering a steerable towing vehicle axle, a towing vehicle lift axle control for lifting or lowering a towing vehicle lift axle; and
wherein the trailer functional unit is formed by at least one unit selected from the group comprising:
a trailer drive system, a trailer clutch/transmission unit having a trailer clutch which can preferably be a constituent part of the trailer drive system, a trailer brake system having at least one trailer braking means, for example a service brake and/or a parking brake and/or a permanent brake, a trailer level control system, a trailer steering system for steering a steerable trailer axle, a trailer lift axle control for lifting or lowering a trailer lift axle.

Accordingly, a raft of functional units which can influence the movement of the towing vehicle, or of the trailer, respectively, and by way of which a corrective movement can therefore can be caused in order to ideally still be able to nevertheless adjust or configure the locked state, are possible.

According to an embodiment it is provided here that the corrective movement is caused in that the towing vehicle drive system and/or the trailer drive system are/is actuated by a jolting movement control signal in such a manner that the towing vehicle and/or the trailer are/is driven in a jolting manner so as to cause a jolting of the towing vehicle and/or the trailer, i.e. a momentary jolting forward and reversing movement of the towing vehicle and/or the trailer. This causes a relative movement, or corrective movement, between the two vehicle parts by way of simple means, by way of which the bracing or incorrect positioning of the coupling elements can be released or eliminated, respectively.

In order for this to be achieved, it can preferably be provided that the towing vehicle clutch/transmission unit and/or the trailer clutch/transmission unit are/is actuated in such a manner that a lowest forward gear or a lowest reverse gear is selected in the corresponding vehicle part, and the towing vehicle clutch and/or the trailer clutch of the respective clutch/transmission unit are/is simultaneously adjusted to an intermediate position in such a manner that the respective clutch is allowed to drag in the lowest forward gear or in the lowest reverse gear. This is a simple possibility in order to automatically generate a jolting movement, or a jolt, respectively, in the present situation, and to configure the locked state of the trailer coupling in this way, for example when bracing or incorrect positioning of the coupling elements is present.

It is preferably furthermore provided herein that in the presence of the jolting movement control signal, the towing vehicle brake system and/or the trailer brake system are/is also actuated in order to decelerate the towing vehicle and/or the trailer in such a manner that the jolting drive of the towing vehicle and/or of the trailer is delimited. The vehicle is thus also decelerated while simultaneously performing the jolting movement, so that the towing vehicle, or the trailer, does not move excessively during the momentary forward or reverse movement, damage due to an excessive approach being able to be avoided as a result. In principle however, such jolting is also possible without such braking, whereby the respective clutch is only briefly ‘released’ and immediately activated again thereafter, whereupon the towing vehicle, or the trailer, respectively, comes to a standstill again immediately.

According to an embodiment it is provided that the corrective movement is caused in that the towing vehicle brake system and/or the trailer brake system are/is actuated by way of a release control signal in such a manner that the towing vehicle braking means and/or the trailer braking means are released so as to move the towing vehicle and/or the trailer optionally as a function of being inclined. Thus, if the vehicle is parked and it is established that a locked state is not present, the braking means are released on at least one vehicle part. If the respective vehicle part is located on a slight gradient, or if the respective vehicle part is parked with chocks, or if there is a bracing effect between the two coupling elements, this releasing of the braking means causes an initial movement, and the desired corrective movement by way of which the bracing or incorrect positioning of the coupling elements can be released, or eliminated, respectively, is automatically achieved.

It is preferably furthermore provided herein that only the towing vehicle braking system is actuated by the release control signal so as to release the towing vehicle braking means, and the trailer braking means in the trailer brake system are or remain applied; or only the trailer brake system is actuated by the release control signal so as to release the trailer braking means, and the towing vehicle braking means in the towing vehicle braking system are or remain applied. In this way, only one vehicle part moves and the other remains stationary, as a result of which a corrective relative movement, or corrective movement, can be caused in an efficient manner.

It can preferably be furthermore provided herein that individual trailer braking means and/or individual towing vehicle braking means are alternatingly released and applied again once or multiple times. In this way, only a minor corrective movement is caused, which however is already sufficient in order to release bracing or incorrect positioning. Moreover, such temporary releasing increases the level of safety.

According to an embodiment it is provided that the corrective movement is caused in that the towing vehicle level control system and/or the trailer level control system are/is actuated by a height control signal in such a manner that a height difference between the towing vehicle-proximal coupling element and the trailer-proximal coupling element is altered. In this way, bracing or incorrect positioning between the coupling elements can also be released or eliminated in a simple manner.

According to an embodiment, altering the height difference, or a corrective movement, respectively, can also be caused in that the towing vehicle lift axle control and/or the trailer lift axle control are/is actuated by a lift axle control signal in such a manner that a towing vehicle lift axle and/or a trailer lift axle is lifted or lowered, and a height difference between the towing vehicle-proximal coupling element and the trailer-proximal coupling element is altered as a result. As a result of the respective lift axle being lifted or lowered in such a manner, the height of the superstructure of the towing vehicle and/or of the trailer is also altered, because the remaining axles are more heavily or less heavily loaded, whereupon the towing vehicle, or the trailer, sinks down or is lifted. Therefore, a corrective movement can be caused in a simple manner also in this way.

According to an embodiment it is provided that the corrective movement is caused in that the towing vehicle drive system and/or the trailer drive system are/is actuated by a drive control signal in such a manner that the towing vehicle moves away from the trailer so as to newly align the two in relation to one another. Thus, if there is bracing or incorrect positioning, the two vehicle parts can also be moved away from one another to a minor extent in such a manner that a controlled approach procedure can be performed again, in which bracing or incorrect positioning of the coupling elements does ideally not occur again. This embodiment can be used, for example, when the corrective movement according to the other embodiments does not lead to the locked state still being configured, i.e. there is potentially bracing or incorrect positioning that cannot be addressed in a simple manner without realignment.

According to an embodiment it is provided that the corrective movement is caused in that the towing vehicle steering system and/or the trailer steering system are/is actuated by a steering control signal in such a manner that the corresponding steerable vehicle axle(s) turn(s), and the stationary towing vehicle and/or the stationary trailer are/is slightly moved by a steering movement of this type. It is therefore advantageously utilized that the respective vehicle part is also slightly set in motion in the event of any steering movement, and a corrective movement can also be caused as a result. This moreover has the advantage that the towing vehicle, or the trailer, per se are not set in movement to such an extent that any risk could arise by virtue of contact with other vehicles or persons. It can preferably be provided herein that the steerable towing vehicle axles on the towing vehicle are turned counter to the steerable trailer axles, this resulting in an opposing and thus maximum corrective movement.

It is preferably furthermore provided that, upon causing the corrective movement, it is newly established by means of at least one item of status information whether the trailer coupling is in a locked state. It is thus verified again whether the corrective movement has actually led to a locked state being configured as expected. It can preferably then furthermore provided that the towing vehicle drive system and/or the trailer drive system are/is actuated in such a manner that the towing vehicle moves away from the trailer, or vice versa, so as to newly align them in relation to one another, for example after the corrective movement has been caused multiple times, for example three times, and when it is in each case independently established by means of at least one item of status information that the trailer coupling is not in the locked state.

The explanations mentioned in the context of causing the corrective movement herein can be applied additionally or alternatively to one another, so as to be able to respond to different incorrect positionings or bracing in the coupling elements. Individual bracing or incorrect positionings can potentially only be eliminated by one of the different corrective movements, so that it could be expedient to apply different corrective movements successively, or if possible in parallel.

It is preferably furthermore provided that the coupling state of the trailer coupling is established by means of at least two items of status information determined independently of one another, for example an item of coupling information and an item of positioning information, once the towing vehicle has approached the trailer, wherein it cannot, or not plausibly, be established whether the locked state of the trailer coupling is present when at least one of the items of status information determined independently of one another indicates that no locked state is not present. Accordingly, it can either be unequivocally determined that an unlocked state, or no locked state, is present if all items of status information indicate the latter, or it cannot be plausibly established whether the locked state is actually present if one status information indicates an unlocked state and another status information indicates a locked state. It can thus be established in a simple manner in this way whether bracing or incorrect positioning is possibly present in the coupling elements, because it can actually be assumed that a locked state would have to be present after the towing vehicle has approached the trailer, but this cannot be confirmed by the status information.

It is preferably provided herein that the coupling state of the trailer coupling is established in at least the following steps:
determining an item of coupling information, wherein the coupling information as a function of
   a position of a locking mechanism of the trailer coupling; and/or
   a towing vehicle jolt; and/or
   a trailer jolt
      indicates whether the trailer coupling could be in the locked state;
determining an item of positioning information, wherein the positioning information as a function of sensor signals of a wave-based sensor installation indicates whether the trailer coupling could be in the locked state; and
determining a coupling result as a function of the coupling information and also as a function of the positioning information, wherein the coupling result indicates whether or not a pivotable connection between the towing vehicle and the trailer by way of the trailer coupling is configured.

Advantageously, at least two mutually independent measuring principles, which also act in different ways, are thus utilized in order to validate the coupling state of the trailer coupling. It is ensured as a result that no wrong coupling state is issued based on an incorrectly determined item of coupling information, because a correct coupling result can only be assumed with a high degree of confidence if the positioning information also indicates the same coupling state. Accordingly, the items of status information, coupling information and positioning information can be checked for mutual plausibility and a final coupling result only issued then, or it can then be concluded for the method according to an embodiment of the invention above whether or not the presence of a locked state is plausible, respectively.

For this purpose, a wave-based sensor installation is preferably utilized, i.e. a sensor installation which evaluates waves or radiation in the visible and invisible wavelength range, for example visible light by a camera, laser radiation in the case of a LIDAR sensor, radar radiation in the case of a radar sensor, and ultrasonic radiation in the case of an ultrasonic sensor. All these wave-based sensor installations allow an item of location information in terms of an object in the environment which participates in the pivotal connection to be determined.

It is preferably furthermore provided that determining the position information comprises the following steps:
determining at least one object in an environment by the wave-based sensor installation and emitting sensor signals, wherein the wave-based sensor installation is disposed on the towing vehicle or the trailer;
determining an item of location information of the detected object, in particular an actual position and/or an actual alignment of the detected object relative to the wave-based sensor installation or relative to the towing vehicle or the trailer on which the wave-based sensor installation is disposed,
   wherein the at least one detected object is the towing vehicle and/or the trailer, or an object connected thereto in the environment which participates in configuring the pivotable connection, for example the towing vehicle-proximal coupling element and/or the trailer-proximal coupling element.

For this purpose, the wave-based sensor installation can be a constituent part of an existing driver assistance system in the vehicle, for example of a reversing assist system, so that no further sensor system has to be installed in the vehicle for this plausibility-checking monitoring of the pivotable connection by determining the position information. It is in particular provided herein that the coupling elements on the towing vehicle and/or on the trailer do not necessarily lie in the detection range of the wave-based sensor installation, because the actual position and/or the actual alignment can be reconstructed by geometric observations, for example from the actual position and/or the actual alignment of the towing vehicle, or of the trailer, respectively. Therefore, in the case that an object in the environment which participates in the configuration of the pivotal connection cannot, or not completely, be detected by the wave-based sensor installation, it can be provided in general that the location information of this object is derived from the items of location information relating to an object in the environment connected to the former. Therefore, no wave-based sensor installation which can completely visually access the trailer coupling, or all coupling elements, respectively, has to be provided explicitly in the region of the trailer coupling.

It can furthermore be provided that determining the position information furthermore comprises the following step:
determining the positioning information as a function of
   whether and to what extent the determined actual position and/or the determined actual alignment and/or the determined location information of the detected object change when the towing vehicle (or the trailer) moves; and/or having the same effect
   whether a relative movement between the towing vehicle and the trailer results from the determined actual position and/or the determined actual alignment and/or the detected location information;
      wherein the positioning information preferably indicates that the trailer coupling could be in the locked state when the determined actual position and/or the determined actual alignment and/or the determined location information of the detected objects do not change when the towing vehicle moves, and/or there is no relative movement present between the towing vehicle and the trailer. It can thus also advantageously be derived from the sensor signals of the wave-based sensor installation whether the towing vehicle can still move relative to the trailer, which can be utilized for validating the coupling information, i.e. in order to confirm, or not confirm, the latter.

It is furthermore preferably provided that the coupling information indicates that the trailer coupling could be in the locked state when it is derived from a movement of the locking mechanism of the trailer coupling and/or from a control signal of an electrical activation mechanism for activating the locking mechanism that the locking mechanism is in a closed position. Information pertaining to the coupling state can thus be derived in a simple manner from a coupling or a locking sensor which is situated on one of the coupling elements.

It is furthermore preferably provided that the towing vehicle jolt and/or the trailer jolt for determining the coupling information are/is determined by way of
a speed sensor on the towing vehicle and/or on the trailer; and/or
an acceleration sensor on the towing vehicle and/or on the trailer. Such a speed or acceleration sensor, respectively, can be, for example, a wheel rotating speed sensor, preferably an active wheel rotating speed sensor which detects the rotating speeds on the respective wheels, whereby the speed, or the acceleration, respectively, can be derived from the rotating speeds. However, other sensors are also conceivable. Therefore, already existing sensors can be utilized in order to conclude a jolt, the latter likewise being able to indicate whether coupling has taken place. When the coupling elements contact one another, there is usually an abrupt change in the speed, or in the acceleration, on the towing vehicle, or on the trailer, respectively. It is thus provided that the coupling information indicates that the trailer coupling could be in the locked state when the towing vehicle jolt and/or the trailer jolt indicate that the trailer-proximal coupling element has contacted the towing vehicle-proximal coupling element, the towing vehicle jolt and/or the trailer jolt in particular reaching or exceeding a jolt critical value.

It is furthermore preferably provided that the coupling information and the positioning information are determined successively or in parallel. Accordingly, depending on the application, it can be decided flexibly in which sequence the items of information are determined and evaluated. It can preferably be provided herein that the positioning information is only determined when the coupling information indicates that the trailer coupling could be in the locked state, or vice versa. It can advantageously be achieved as a result, that data has to be first recorded and evaluated only for one of the possibilities, and a further evaluation of data for checking or validating the plausibility takes place only thereafter.

It is furthermore preferably provided that when the coupling information and also the positioning information indicate that the trailer coupling could be in the locked state, it is additionally determined whether the towing vehicle jolt and/or the trailer jolt reach or exceed an established jolt critical value, in particular within a temporal offset once the towing vehicle has been set in motion, and the coupling result indicates that a pivotable connection between the towing vehicle and the trailer is configured when the established jolt critical value has been reached. Accordingly, it can be determined once again even after a validated coupling state, whether the trailer is being entrained with a temporal offset by virtue of play in the coupling once the towing vehicle has driven off.

It is furthermore preferably provided that the coupling result indicates that a pivotable connection between the towing vehicle and the trailer is configured when the coupling information and also the positioning information indicate that the trailer coupling could be in the locked state.

Further provided according to an embodiment of the invention is a state determination assembly for configuring a pivotable connection between a towing vehicle and a trailer by way of a trailer coupling in particular according to the method according to an embodiment of the invention, having a state determination unit, wherein the state determination unit is configured to
establish a coupling state of the trailer coupling by means of at least one status information, once the towing vehicle has approached the trailer; and
generate and emit control signals so as to cause a corrective movement in such a manner that the trailer and the towing vehicle move relative to one another, wherein the corrective movement can be caused when it cannot, or not plausibly, be established by means of the at least one item of status information whether the locked state of the trailer coupling is present.

Also provided according to an embodiment of the invention is a vehicle, in particular commercial vehicle, consisting of a towing vehicle and a trailer, wherein a pivotable connection between a towing vehicle-proximal coupling element on the towing vehicle and a trailer-proximal coupling element on the trailer can be configured by way of a trailer coupling when a locking mechanism of the trailer coupling is moved to a close position, wherein the vehicle furthermore has the state determination assembly according to an embodiment of the invention for configuring a pivotable connection between the towing vehicle and the trailer by way of the trailer coupling. The trailer coupling herein can preferably be
embodied as a pin coupling in which an eyelet on a drawbar as a trailer-proximal coupling element, by way of a coupling pin as a locking mechanism, can be held in a clevis as a towing vehicle-proximal coupling element so as to configure a pivotable connection; or
embodied as a fifth-wheel coupling in which a kingpin as a trailer-proximal coupling element, by way of a coupling claw as a locking mechanism, can be held on a fifth-wheel plate as a towing vehicle-proximal coupling element so as to configure a pivotable connection. Therefore, a flexible use for different types of couplings is provided.

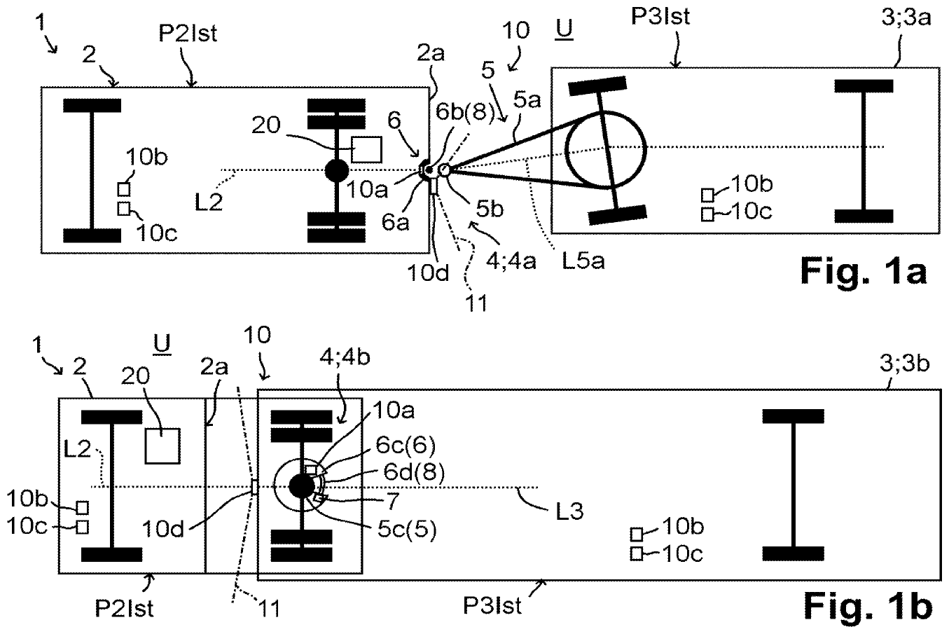

FIGS. 1a and 1b both schematically show a vehicle 1 which includes a towing vehicle 2 and, coupled thereto, a trailer 3, wherein a pivotable connection V between both is configured by way of a trailer coupling 4. In FIG. 1a, the trailer 3 is a drawbar trailer 3a having a drawbar 5a and an eyelet 5b, disposed on the latter, as a trailer-proximal coupling element 5, and a clevis 6a having a coupling pin 6b as a towing vehicle-proximal coupling element 6. Accordingly, the trailer coupling 4 is embodied in the manner of a pin coupling 4a in which the eyelet 5b of the drawbar 5a is held in the clevis 6a by way of the coupling pin 6b as a locking mechanism 8, thus configuring a pivotable connection V between the drawbar trailer 3a and the towing vehicle 2. Depending on the embodiment of the drawbar trailer 3a, the drawbar 5a can be connected rigidly to the trailer chassis (rigid drawbar) or in an articulated manner to the latter (centre pivot plate).

In FIG. 1b, the trailer 3 is a semi-trailer 3b having a kingpin 5c as a trailer-proximal coupling element 5, and a fifth-wheel plate 6c having a coupling claw 6d as a towing vehicle-proximal coupling element 6. Accordingly, the trailer coupling 4 is embodied in the manner of a fifth-wheel coupling 4b in which the kingpin 5c is held on the fifth-wheel plate 6c by way of the coupling claw 6d as a locking mechanism 8, thus configuring a pivotable connection V between the semi-trailer 3b and the towing vehicle 2 (road semi-trailer). The two vehicles 1 in FIGS. 1aand 1b accordingly differ from one another in particular in terms of the type of the trailer coupling 4.

In both variants illustrated, the trailer coupling 4 can be in a locked state ZV or in an unlocked state ZE, whereby these two coupling states Z can be adjusted by adjusting or moving the locking mechanism 8, i.e. the coupling pin 6b (pin coupling 4a) or the coupling claw 6d (fifth-wheel coupling 4b), for example by means of an electrical activation mechanism 7. When the eyelet 5b is correctly positioned in the clevis 6a, or the kingpin 5c in the fifth-wheel plate 6c, a distance-altering relative movement between the respective trailer 3 and the towing vehicle 2 can be prevented in the locked state ZV of the trailer coupling 4, or correspondingly enabled in the unlocked state ZE of the trailer coupling 4. A pivoting movement, and a relative movement between the trailer 3 and the towing vehicle 2 arising by virtue of wear in the trailer coupling 4 are not considered to be distance-altering relative movements in the context of the present disclosure.

The coupling state Z, which characterizes the state of the pivotable connection V configured between the towing vehicle 2 and the trailer 3 by way of the trailer coupling 4, can be monitored or established by a state determination unit 20 in a state determination assembly 10. This herein is performed by verifying a plausibility, i.e. two items of status information ZI are used which are determined dependently of one another and in each case correlate in some way with the coupling state Z, or from which this coupling state Z can be derived, respectively. The state determination unit 20 herein can be, for example, a constituent part of a towing vehicle brake system 2e (EBS, electronic brake system) or of a trailer brake system 3f (T(railer)EBS).

According to an exemplary embodiment, the two items of status information ZI, which are determined independently of one another, i.e. an item of coupling information KI and an item of positioning information PI, are utilized as follows:

The state information assembly 10 can comprise, for example, a position sensor 10aby way of which it can be determined directly, or monitored directly, in which position S the locking mechanism 8 (coupling pin 6b, or coupling claw 6d) is, i.e. in a closed position SG or in an open position SO. In the respective closed position SG, the locking mechanism 8 is capable of producing and maintaining a pivotable connection V between the trailer-proximal coupling element 5 and the towing vehicle-proximal coupling element 6, as long as the eyelet 5b, and the kingpin 5c, respectively, are correctly positioned in the clevis 6a, or on the fifth-wheel plate 6c, respectively (corresponds to the locked state ZV of the trailer coupling 4). In contrast, this pivotable connection V is not maintained in the open position SO (corresponds to the unlocked state ZE of the trailer coupling 4). For this purpose, the position sensor 10a can monitor, for example, the movement of the locking mechanism 8, i.e. of the coupling pin 6b, or the coupling claw 6d, and/or activation signal is S7 of the electrical activation mechanism 7. The coupling state Z of the trailer coupling 4 as a function of the position S; SG, SO determined by the position sensor 10a can be derived in the state determination unit 20.

According to an alternative or additional embodiment, it can be provided that the state determination assembly 10 comprises or has an acceleration sensor 10b and/or a speed sensor 10c, which are disposed on the towing vehicle 2 and/or on the trailer 3, whereby these can already be present in the vehicle 1, for example as a constituent part of another vehicle unit. A towing vehicle jolt j2 and/or a trailer jolt j3 can be determined from the towing vehicle acceleration a2 and/or trailer acceleration a3, and/or towing vehicle speed v2 and/or trailer speed v3, measured by said sensors (first temporal derivative of the respective acceleration a2, a3; second temporal derivative of the respective speed v2, v3).

The acceleration sensor 10b and/or the speed sensor 10c, which are only schematically illustrated in FIG. 1, can be embodied as, for example, wheel rotating speed sensors on the individual wheels of the towing vehicle 2, or of the trailer 3, respectively, which measure the rotating speeds of the wheels from which the speed or the acceleration is derived, respectively. Sensors which already exist in the vehicle can therefore be utilized.

If a brief change in speed or acceleration, or a corresponding jolt j2, j3, which reaches or exceeds a previously established jolt critical value jGW, is detected it can be concluded in the state determination unit 20 that this results from contact between the trailer-proximal coupling element 5 and the towing vehicle-proximal coupling element 6. The coupling state Z of the trailer coupling 4 can also be derived therefrom in the state determination unit 20, whereby a locked state ZV of the trailer coupling 4 is only to be expected if the eyelet 5b, or the kingpin 5c, has contacted the clevis 6a, or the fifth-wheel plate 6c in a correct position, respectively.

The coupling information KI which is utilized in the method described, for example, is derived from at least one of these possibilities described, i.e. by way of the position sensor 10a and/or the acceleration sensor 10b and/or the speed sensor 10c. The coupling information KI in this instance only indicates that the trailer coupling 4 could be in the locked state ZV, because correct positioning of the coupling element 5, 6 cannot be verified by way of these possibilities. The coupling information KI herein can also be determined while utilizing a plurality of the possibilities mentioned, in that the plausibility of the position S: SG, SO of the locking mechanism 8 monitored or established by way of the position sensor 10a is verified using the jolt j2, j3 monitored or established by way of the acceleration sensor 10b and/or speed sensor 10c, so as to obtain reliable coupling information KI.

In a coupling information KI determined in such a manner, the state determination unit 20 can thus not reliably establish the coupling state Z of the trailer coupling 4 actually present. This is due to the fact that it cannot be ensured whether the eyelet 5b is correctly positioned in the clevis 6, or the kingpin 5c is correctly positioned in the fifth-wheel plate 6c, respectively, when the coupling pin 6b, or the coupling claw 6, respectively, are moved to the closed position SG. When incorrectly positioned, a correspondingly established jolt j2, j3 which is above the jolt critical value jGW can also lead to an incorrectly derived coupling state Z. In order to further verify the plausibility of the coupling state Z of the trailer coupling 4, the state determination unit 20 therefore additionally utilizes the sensor signals S10d of a wave-based sensor installation 10d which is disposed on the towing vehicle 2 or on the trailer 3, and with the aid of which an item of positioning information PI can be determined.

The wave-based sensor installation 10d can be formed by a camera 15a, or have such a camera 15a, for example, wherein the camera 15a is capable of detecting in a space-resolved manner an object O in the environment U of said camera 16a by way of an image sensor which detects electromagnetic radiation, in particular in the visible range, emitted/reflected by the object O, and as a function thereof generate and emit the sensor signals S10d. Alternatively or additionally to the camera 15a, a LIDAR sensor 15b which scans the environment U with laser beams and detects reflected laser radiation can be provided, so that an object O in the environment U can be “imaged” in a space-resolved manner. Comparable imaging principles based on the reflection of waves or radiation, by way of which objects O in the environment U can be scanned, can be implemented with a radar sensor 15c and/or an ultrasonic sensor 15. These imaging principles based on the reflection of waves or radiation herein are based on determining by way of a time-of-flight measurement of the respective radiation a distance from an object point on the respective object O in the environment U, onto which the respective sensor 15b, 15c, 15c is directed. If the distances from a plurality of object points on an object O are determined by changing the alignment of the respective sensor 15b, 15c, 15d (scanning), an image of the respective object O can be generated in this way.

Therefore, the state determination unit 20, as a function of the generated and emitted sensor signals S10d of the sensor installation 10d, is capable of utilizing an “image” of an object O in the environment U which participates in configuring the pivotable connection V, i.e. the towing vehicle 2 and/or the respective trailer 3, so as to validate the coupling state Z. If the wave-based sensor installation 10d is installed on the towing vehicle 2, as illustrated in FIG. 1a, the detection range 11 of said sensor installation 10d is in particular directed rearwards so as to be able to detect a trailer 3 situated there. For this purpose, the wave-based sensor installation 10d can be disposed on a rear 2a of the towing vehicle 2 as a constituent part of an existing driver assistance system, for example a reversing assist system, for example. Or else, as is illustrated in FIG. 1b, the wave-based sensor installation 10d can be installed on the trailer 3, whereby the detection range 11 thereof is then directed forwards in particular onto the towing vehicle 2, so as to be able to detect the towing vehicle 2.

This enables the state determination unit 20 to determine from the sensor signals S10d of the sensor installation 10d an actual position P3Ist of the trailer 3 and/or an actual alignment A3Ist of the trailer 3 relative to the sensor installation 10d on the towing vehicle 2, for example. If the sensor installation 10d is disposed on the trailer 3, an actual position P2Ist of the towing vehicle 2 and/or an actual alignment A2Ist of the towing vehicle 2 relative to the sensor installation 10d on the trailer 3 can be correspondingly estimated from the sensor signals S10d of the sensor installation 10d, for example. Or else an actual position P5Ist and/or an actual alignment A5Ist of the trailer-proximal coupling element 5, for example of the drawbar 5a, relative to a sensor installation 10d on the towing vehicle 2, and also an actual position P6Ist and/or an actual alignment A6Ist of the towing vehicle-proximal coupling element 6, for example of the clevis 6a or the fifth-wheel plate 6d, relative to a sensor installation 10d on the trailer 3 can furthermore be estimated from the sensor signals S10d, when these positions/alignments are situated in the detection range 11 of the sensor installation 10d.

The actual position POIst of the respectively detected object O (2, 3, 4, 5) which participates in configuring the pivotable connection herein can be described by one or a plurality of established reference points on the respectively detected object O. The actual alignment AOIst of the respectively detected object O (2, 3, 4, 5) relates, for example, to a longitudinal central axis L2, L3 of the detected towing vehicle 2, or of the detected trailer 3, respectively. The respective object O can thus be correspondingly reconstructed from the actual position POIst and the actual alignment AOIst. The sensor position and the sensor orientation of the sensor installation 10d on the towing vehicle 2, or on the trailer 3, respectively, relative to an established reference point, or to the longitudinal central axes L2, L3 of the towing vehicle 2, or of the trailer 3, respectively, are inter alia also taken into account, for example, whereby this follows on from a previous calibration of the sensor installation 10d.

In this way, items of location information LI relating to the respectively detected object O in the environment U which participates in configuring the pivotable connection, i.e. in particular of the towing vehicle 2, of the trailer 3 and of the coupling elements 5, 6 can generally be obtained from the sensor signals S10d of the sensor installation 10d, wherein it is derived from the items of location information LI how the trailer 3 is positioned relative to the towing vehicle 2, or the trailer-proximal coupling element 5 is positioned relative to the towing vehicle-proximal coupling element 6, respectively. Corresponding image algorithms are used for this purpose, for example an edge identification so as to be able to unequivocally identify the towing vehicle 2, or the trailer 3, or the coupling elements 5, 6 by means of the sensor signals S10d, respectively.

If the respective coupling element 5, 6 herein is not situated directly or completely in the detection range 11 of the sensor installation 10d, the actual position P5Ist, P6Ist and/or the actual alignment A5Ist, A6Ist of the respective coupling element 5, 6 can also be derived from the geometric observations, as long as the latter are rigidly fastened to the towing vehicle 2, or to the trailer 3, respectively, or are invariable thereon. For example, if the sensor installation 10d is disposed on the towing vehicle 2, and the eyelet 5b, and optionally also part of the drawbar 5a, are not (no longer) detectable by the sensor installation 10d, the actual position P5Ist and/or the actual alignment A5Ist of the drawbar 5 including the eyelet 5b (trailer-proximal coupling element 5) can also be reconstructed by means of the established superstructure and the dimensions of the drawbar 5a. The superstructure and the dimensions of the drawbar 5a herein are stored in the state determination unit 20, for example, or the latter can utilize the these in another way, for example based on images taken previously.

In the presence of a rigid drawbar or a kingpin 5c, which are in each case fastened rigidly to the trailer 3, where these are not (no longer) detectable by the sensor installation 10d, the actual position P5Ist and/or the actual alignment A5Ist of these trailer-proximal coupling elements 5 can also be derived from the determined actual position P3Ist and/or the actual alignment A3Ist of the trailer 3, for example. Also in this case, the superstructure and the dimensions of the respective trailer-proximal coupling element 5 and also the fixed position thereof on the trailer 3 are known, and the state determination unit 20 can utilize those for further geometric observations.

As described, the actual position POIst, or the actual alignment AOIst, respectively, of the respectively detected object O relative to the sensor installation 10d can be indicated. It can also be derived therefrom by way of geometric observations, while taking into account the sensor position and the sensor orientation, how the respectively detected object O is positioned relative to the coupling element 5, 6 of that vehicle part on which the sensor installation 10d is disposed. Accordingly, the actual position P5Ist and the actual orientation A5Ist of the drawbar 5a including the eyelet 5b relative to the clevis 6a can be indicated, for example, when the sensor installation 10d is situated on the towing vehicle 2 and has previously been correspondingly calibrated. In an analogous manner, this applies to a disposal of the sensor installation 10d on the trailer 3, whereby the actual position P6Ist and the actual orientation A6Ist of the clevis 6a in relation to the drawbar 5a, or in relation to the eyelet 5b, respectively, in this case can be derived from geometric observations. The same applies in an analogous manner to an embodiment of the trailer coupling 4 as a fifth-wheel coupling 4b.

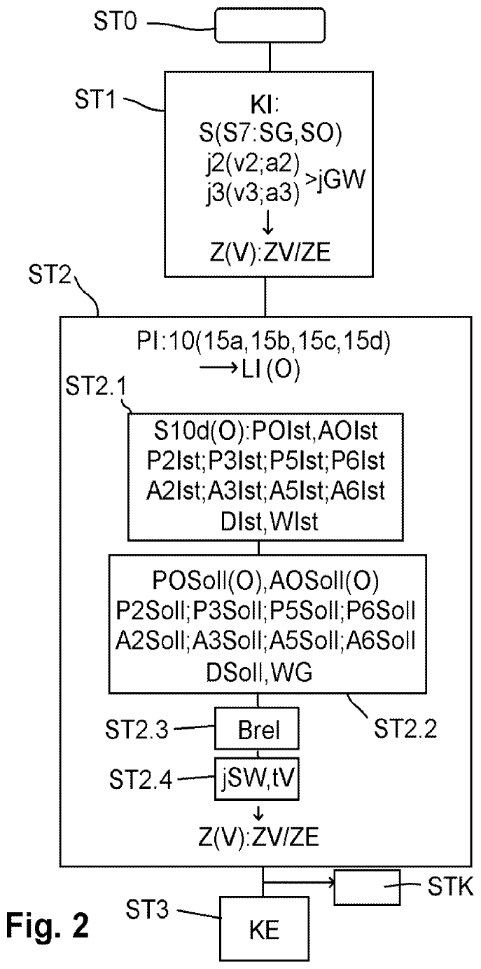

While utilizing these described components in the vehicle 1, the coupling state Z of the trailer coupling 4 according to FIG. 2 can be monitored or determined by the state determination unit 20 as follows:

In an initial step STO, the method is initialized, for example with the beginning of a coupling procedure in which the trailer 3 is to be coupled to the towing vehicle 2. In a first step ST1, the coupling information KI is determined, i.e. whether it can be derived as described above by means of the monitored or established position S; SG, SO of the coupling pin 6b, or of the coupling claw 6d, respectively, (by way of the position sensor 10a), and/or by means of the monitored jolt j2, j3 (by way of the exhilaration sensor 10b and/or the speed sensor 10c), when said jolt j2, j3 reaches or exceeds the established jolt critical value jGW, that the trailer coupling 4 could be in a locked state ZV. If this is not the case, waiting continues until this is the case.

If it is derived in the first step ST1 that the trailer coupling 4 could be in a locked state ZV, this is validated or verified in a second step ST2 in the state determination unit 20 by way of the wave-based sensor installation 10d in that the positioning information PI is determined independently of the coupling information KI. For this purpose, the actual position POIst and/or the actual alignment AOIst of the respective object O (towing vehicle 2 or trailer 3), or of the respective coupling element 5, 6, respectively, is determined or estimated as described above in a first intermediate step ST2.1.

In a second intermediate step ST2.2, the determined actual position POIst and/or the determined actual alignment AOIst of the respective object O are/is reconciled with an established setpoint position POSoll, or a setpoint alignment AOSoll, respectively, for the respective object O so as to derive therefrom the positioning information PI from which it is likewise derived whether the trailer coupling 4 could be in the locked state ZV. It is thus verified by means of the items of location information LI whether the towing vehicle 2 or the trailer 3 of the respective coupling element 5, 6 are aligned and positioned in such a manner as is to be expected for the locked state ZV of the trailer coupling 4. The respective setpoint position POSoll, or the setpoint alignment AOSoll, respectively, of the respective object O is thus chosen or established in such a manner that in the case of a pin coupling 4a the eyelet 5b on the drawbar 5a is correctly positioned and aligned in the clevis 6a, or in the case of a fifth-wheel coupling 4b the kingpin 5c is correctly positioned and aligned in the fifth-wheel plate 6c.

That setpoint position POSoll, or setpoint alignment AOSoll, respectively, that is assigned to a visible or sufficiently visible object O can be chosen for the reconciliation herein. If the kingpin 5c or the eyelet 5b, or part of the drawbar 5a, are not visible to a sensor installation 10d on the towing vehicle 2, the setpoint position P3Soll of the trailer 3 is utilized for reconciliation with the actual position P3Ist of the trailer 3, from which it can likewise be estimated whether the kingpin 5c, which is rigidly connected thereto, or the eyelet 5b or the drawbar 5a is correctly positioned or aligned in relation to the fifth-wheel plate 6c, or in relation to the clevis 6a, respectively. This applies in an analogous manner to the clevis 6a or the fifth-wheel plate 6c which are not visible to a sensor installation 10d on the trailer 3, the correct positioning and alignment thereof also being able to be derived from an setpoint/actual reconciliation of the position of the towing vehicle 2.

In the context of such a setpoint/actual reconciliation from which the positioning information PI is derived, it can also be provided, for example, that the trailer 3 is detected by way of the sensor installation 10d, and an actual distance DIst between a reference point on the drawbar 5a as a trailer-proximal coupling element 5, from a reference point on the towing vehicle 2, for example from the clevis 6a as a towing vehicle-proximal coupling element 6, is determined from the actual position P3ist and the actual orientation A3Ist. A conclusion pertaining to a locked state ZV herein can be drawn when the actual distance DIst has reached a setpoint distance DSoll, the latter being derived from the established setpoint position P3Soll, or setpoint alignment A3Soll of the trailer 3. In order to also take into account the alignment of the trailer 3, or of the drawbar 5a, respectively, in the process, an actual angle WIst between a longitudinal central axis L5a of the drawbar 5a and the longitudinal central axis L2 of the towing vehicle 2 can also be determined from the actual position P3Ist and the actual orientation A3Ist of the trailer 3. As a function thereof, it can additionally be verified, for example, whether a critical angle WG is exceeded, i.e. the actual angle WIst is too acute in order to be able to obtain a locked state ZV in the first place. A perceived locked state ZV determined in the first step STI can also be verified or validated in this way.

If temporal monitoring of the sensor signals S10d takes place by the state determination unit 20, it can additionally be verified in a third intermediate step ST2.3 whether and to what extent the actual position POIst and/or the actual alignment AOIst change, once it has already been established in the first step ST1 that a locked state ZV of the trailer coupling 4 could be present, and/or a match with the setpoint position POSoll and/or setpoint orientation AOSoll of the respective object O has also been established in the second intermediate step ST2.2. It can thus be verified whether a relative movement Brel between the towing vehicle 2 and the trailer 3, or between the coupling elements 5, 6, respectively, occurs during coupling, this indicating that a locked state ZV is incorrectly assumed, or another defect is present. In this case, the towing vehicle 2 is to be correspondingly braked in order to avoid damage.

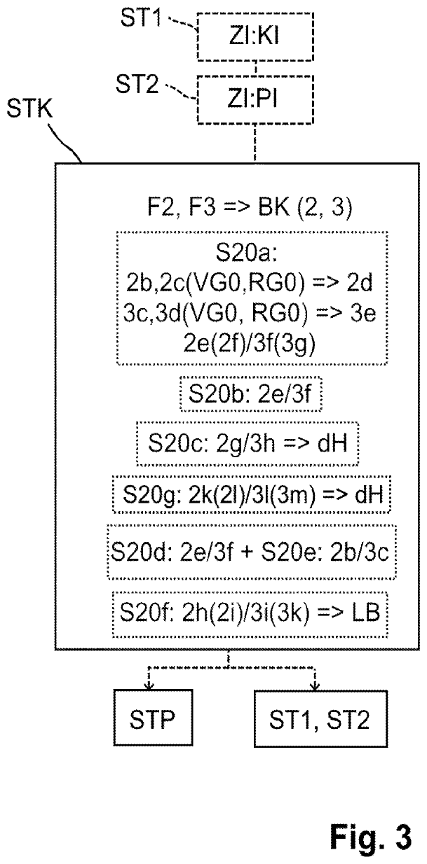

Once it has already been established in the first step ST1 that a locked state ZV of the trailer coupling 4 could be present, and/or a match with the setpoint position POSoll and/or setpoint orientation AOSoll of the respective object O has also been established in the second intermediate step ST2.2, it can furthermore be verified in a fourth intermediate step ST2.4 whether the above-described jolt j2, j3 on the towing vehicle 2 and/or on the trailer 3 reaches or exceeds an established jolt threshold value jSW, once the towing vehicle 2 is set in motion. If a locked state ZV of the trailer coupling 4 is actually present, it is to be expected that the trailer 3 is entrained within a temporal offset tV of, for example, at most 2 s, preferably at most 1.5 s, after the towing vehicle 2 has started moving, this being noticeable in a brief abrupt increase in the jolt j2, j3 within the temporal offset tV. The temporal offset tV is established in such a manner that minor play in the coupling connection is also taken into account, which is why the trailer 3 is not immediately entrained. If this abrupt increase to or beyond the jolt threshold value jSW cannot be determined, this does not suggest an unlocked state ZE of the trailer coupling 4, or if this increase to or beyond the jolt threshold value jSW is determined, a locked state ZV previously supposedly determined can be confirmed. The intermediate step ST2.4 can in principle also take place even later, in particular also between the second step ST2 and the third step ST3 in FIG. 3, so as to verify a determined coupling state Z.

If a locked state ZV previously supposedly determined is not confirmed or determined in this way (intermediate step ST2.4) or in another way (intermediate steps ST2.3, ST2.2) in the context of the method described, a brake on the towing vehicle 2 and optionally also on the trailer 3 can be applied, for example, so as to avoid damage to lines which can have already been connected. Furthermore, a corrective step STK can be initiated, as described hereunder.

However, if a conclusion pertaining to a locked state ZV is drawn in this way in the second intermediate step ST2.2 (actual =setpoint) and/or the third intermediate step ST2.3 (Brel=0) and/or the fourth intermediate step ST2.4 (j2, j3 >=jSW), i.e. the previous determination in the first step ST1 is validated or plausibly confirmed, it is emitted in a first step ST3 by means of the coupling information KI and positioning information PI, determined independently of one another, as the coupling result KE that a correct pivotable connection V by way of the trailer coupling 4 is configured with a high degree of probability. The vehicle 1 can then subsequently start its journey.

It is also possible to deviate from the sequence described, in which the coupling information KI is determined before the positioning information PI. Accordingly, the first positioning information PI can also be determined by permanent temporal monitoring of the environment U, and the first coupling information KI can be subsequently determined if it is derived from the positioning information PI that a locked state ZV could be present. Both items of information KI, PI can however also be continuously verified in parallel.

As described above, a corrective step STK is carried out according to an embodiment of the invention should the coupling state Z determined in the first step ST1 not plausibly match the coupling state Z determined independently of the former in the second step ST2, or the determined coupling states Z in each case indicate an unlocked state ZE, for example when the adjustment of the locked state of the trailer coupling is prevented. The corrective step STK, which is described hereunder by means of FIG. 3, can in principle also be carried out if it cannot, or not plausibly, be established in another way than described (steps ST1, ST2) by means of at least one determined status information ZI, which relates to the coupling state Z, or from which the coupling state Z can be derived, respectively, that a correct pivotable connection V between the towing vehicle 2 and the trailer 3 is configured by way of the trailer coupling 4.

Proceeding therefrom, in the corrective step STK a corrective relative movement Brel, or a corrective movement BK between the towing vehicle 2 and the trailer 3, or between the towing vehicle-proximal coupling element 6 and the trailer-proximal coupling element 5, respectively, is caused in that a towing vehicle functional unit F2 in the towing vehicle 2 and/or trailer functional unit F3 in the trailer 3 are/is automatically actuated as described hereunder. Accordingly, the above-determined actual alignment AOIst and/or the actual position POIst of the respective objects O participating in the coupling procedure are corrected so as to nevertheless ideally transfer the trailer coupling 4 to the locked state ZV.

It is assumed here that the pivotable connection V between the towing vehicle 2 and the trailer 3 is not correctly configured, or the adjustment of the locked state ZV of the trailer coupling 4 is prevented, because bracing has occurred between the coupling elements 5, 6. This bracing can arise, for example, because the coupling elements 5, 6 are not mutually positioned at the correct height, or are positioned obliquely in relation to one another. At least one of the items of status information ZI, in the determination of which bracing of this type is not taken into account (cannot be taken into account), can in this case nevertheless indicate a locked state ZV in such a way that the locked state ZV cannot be plausibly established.

The corrective step STK, or causing a corrective movement BK between the towing vehicle 2 and the trailer 3, or between the coupling elements 5, 6, respectively, is to have the effect that potential bracing between the coupling elements 5, 6 is alleviated and the pivotable connection Vis, or can be, subsequently correctly configured as a result, so that the locked state ZV of the trailer coupling 4 is obtained. Causing the corrective movement BK between the towing vehicle 2 of the trailer 3 herein can take place in different ways, whereby only a minor corrective movement BK is preferably induced by correspondingly activating the towing vehicle functional unit F2 and/or the trailer functional unit F3, as described hereunder:

According to a first embodiment it is provided that the towing vehicle 2 and/or the trailer 3 are/is briefly driven in a jolting manner by corresponding electrical activation of a towing vehicle drive system 2b, or of a trailer drive system 3c, should this trailer 3 have such a functionality (e-Trailer), so as to correspondingly briefly set in forward or reverse motion the towing vehicle 2 and/or the trailer 3, i.e. to cause a so-called jolting movement. For this purpose, a jolting movement control signal S20a is for example emitted to the towing vehicle drive system 2b, or the trailer drive system 3c, respectively, by the state determination unit 20 in the context of the corrective step STK.

As a function of the jolting movement control signal S20a, a towing vehicle clutch/transmission unit 2c in the towing vehicle drive system 2b, or a trailer clutch/transmission unit 3d in the trailer drive system 3c, respectively, is actuated in such a manner that the lowest forward gear VGO or the lowest reverse gear RGO is selected. For jolting, or starting in a jolting manner, a towing vehicle clutch 2d, or a trailer clutch 3e, respectively, of the respective clutch/transmission unit 2c, 3d is adjusted to an intermediate position, i.e. the respective clutch 2d, 3d is allowed to drag in the lowest forward gear VG0, or reverse gear RG0, respectively, so that the towing vehicle 2 and/or the trailer 3 move/moves just very slightly in a jolting manner in the respective direction (forward/reverse), for example by only a few centimetres.

This thus leads to a minor movement of the towing vehicle 2 and/or of the trailer 3, and as a result also to a corrective movement BK between the towing vehicle 2 and the trailer 3, as a result of which the bracing in the coupling elements 5, 6 is released and the locked state ZV of the trailer coupling 4 can ideally be adjusted.

It can be additionally provided herein that in the presence of the jolting movement control signal S20a a towing vehicle brake system 2e, or a trailer brake system 3f (if present), respectively, is also actuated so as to decelerate the towing vehicle 2, or the trailer 3, respectively, by actuating towing vehicle braking means 2f, or trailer braking means 3g, respectively, for example service brakes of parking brakes, and to therefore to delimit the jolting drive movement of the towing vehicle 2, or of the trailer 3, respectively, i.e. to permit only very slight jolting in the respective direction.

According to a second embodiment, which can be used additionally or alternatively to the first embodiment or the embodiments hereunder, it is provided that the towing vehicle braking system 2e and/or the trailer braking system 3f (if present) are/is actuated in such a manner in the corrective step STK that the towing vehicle braking means 2f, or the trailer braking means 3g, respectively, are released, preferably axle-by-axle, e.g. initially a tandem axle or a steering axle when using a centre pivot plate trailer. The towing vehicle braking means 2f herein are preferably released while the trailer braking means 3g are or remain applied, or vice versa, so that a corrective movement BK between the towing vehicle 2 on the trailer 3 is caused in any case.

This is based on the concept that the towing vehicle-proximal coupling element 6 and/or the trailer-proximal coupling element 5, for example the drawbar 5a, or the towbar, can be braced, so that the trailer coupling 4 does not correctly close. If the towing vehicle braking means 2f or the trailer braking means 3g are released in this braced state, for example in that a release control signal S20b is transmitted to the towing vehicle braking system 2e and/or to the trailer braking system 3f (provided the supply lines are already plugged in) by the state determination unit 20 in the corrective step STK, this can automatically lead to an at least minor movement of the towing vehicle 2 and/or of the trailer 3 depending on the environmental conditions such as, for example, an inclination of the substrate, and/or by virtue of bracing present between the two coupling elements 5, 6. This results in a corrective movement BK between the towing vehicle 2 and the trailer 3, in particular when the respective other vehicle part remains braked. As a result, the bracing in the coupling elements 5, 6 can be released, and the locked state ZV of the trailer coupling 4 can ideally be adjusted. It is thus likewise an objective of this second embodiment to remove the bracing from the coupling elements 5, 6 by a corrective movement BK.

In order to cause a movement of the trailer 3, for example, even in the absence of an inclination of the substrate, or in the case of only minor bracing of the coupling elements 5, 6, releasing the trailer braking means 3g can take place, for example, when wheel chocks are situated on at least one wheel of the trailer 3, or when the trailer 3 is secured in another way. If wheel chocks of this type are not present, for example in (fully) automatically operated vehicles 1, it is to be ensured that the combination consisting of the towing vehicle 2 and the trailer 3 does not roll away, whereby individual trailer braking means 3g and/or towing vehicle braking means 2f can be alternatingly activated or released for this purpose, until the locked state ZV of the trailer coupling 4 has been established, for example.

In a third embodiment, which can be used additionally or alternatively to at least one of the preceding or following embodiments, a subsequent height correction of the towing vehicle 2 in relation to the trailer 3 is provided in the context of the corrective step STK. It is therefore assumed that bracing of the coupling elements 5, 6 is caused by an inappropriate or unfavourable height adjustment.

In this case, the state determination unit 20 in the corrective step STK sends a height control signal S20c to a towing vehicle level control system 2g (ECAS, Electronically Controlled Air Suspension) and/or a trailer level control system 3h so as to alter a height difference dH between the two coupling elements 5, 6, for example by 10 cm up and/or down. This thus leads to a minor movement of the towing vehicle 2 and/or of the trailer 3 in terms of height, and as a result also to a corrective movement BK between the towing vehicle 2 and the trailer 3, as a result of which the bracing in the coupling elements 5, 6 is released and the locked state ZV of the trailer coupling 4 can ideally be adjusted.

In a fourth embodiment, which can be used additionally or alternatively to at least one of the preceding or following embodiments, a subsequent height correction of the towing vehicle 2 in relation to the trailer 3 is provided in the context of the corrective step STK, in that the state determination unit 20 transmits a lift axle control signal S20g to a towing vehicle lift axle control 2k and/or a trailer lift axle control 31, so as to alter the height difference dH between the two coupling elements 5, 6. This leads to one towing vehicle lift axle 21 and/or one trailer lift axle 3m being lowered or lifted, whereupon the superstructure of the towing vehicle 2, or of the trailer 3, respectively, is lowered or lifted because the respective other axles are more or less heavily loaded. This also leads to a minor movement of the towing vehicle 2 and/or of the trailer 3 in terms of height, and as a result also to a corrective movement BK between the towing vehicle 2 and the trailer 3, as a result of which the bracing in the coupling elements 5, 6 is released, and the locked state ZV of the trailer coupling 4 can ideally be adjusted.

In a fifth embodiment, which can also be used after unsuccessfully carrying out at least one of the preceding or following embodiments, for example after unsuccessfully applying one of the other embodiments three times, the renewed alignment of the towing vehicle 2 and/or of the trailer 3 is provided in the context of the corrective step STK. If it cannot, or not plausibly, be established by means of the items of status information ZI, determined independently of one another, that a correct pivotable connection V between the towing vehicle 2 and the trailer 3 is configured by way of the trailer coupling 4, and at least one of these items of status information ZI additionally indicates that the coupling elements 5, 6 are not correctly positioned in relation to one another in order to configure a correct pivotable connection V, realignment is provided.

For example, if the clevis 6a or the fifth-wheel plate 6c is still open while the actual distance DIst addressed in the second intermediate step ST2.2 has already reached or undershot a setpoint distance DSoll of, for example, 2m, this indicates that the eyelet 5b on the drawbar 5a has missed the clevis 6a, or the kingpin 5c has missed the fifth-wheel plate 6c. If an actual distance DIst of 2m is undershot in the process, and the information is also furthermore provided by way of the coupling information KI that the coupling pin 6b, or the coupling claw 6d is in the open position SO, respectively, the towing vehicle 2 and/or the trailer 3 are/is initially braked in that the state determination unit 20 transmits a corresponding brake control signal S20d to the towing vehicle brake system 2e and/or the trailer brake system 3f. Otherwise, this could lead to damage to the towing vehicle 2 or the trailer 3, or the drawbar 5a or the kingpin 5c could be damaged if the latter have missed and the coupling procedure continues.

Subsequently, the state determination unit 20 sends a drive control signal S20e to the towing vehicle drive system 2b and/or the trailer drive system 3c, so as to correspondingly move the towing vehicle 2 and/or the trailer 3 away from one another so that both can be newly aligned in relation to one another. Subsequently, a new coupling procedure, or approach procedure, of the coupling elements 5, 6 can take place, in which bracing between the coupling elements 5, 6 ideally no longer occurs.

According to a sixth embodiment, which can be used additionally or alternatively to at least one of the preceding embodiments, it is provided in the context of the corrective step STK to set in motion the stationary towing vehicle 2 and/or the stationary trailer 3 by a steering movement LB of a steerable towing vehicle axle 2i and/or a steerable trailer axle 3k. If the coupling elements 5, 6 are braced, and the trailer coupling 4 therefore does not flawlessly close, such a steering movement LB in the stationary state can help to release this bracing. As a result of the steering movement LB, for example on a front axle of the towing vehicle 2, the complete towing vehicle 2 also moves slightly, in particular the rear 2a of the vehicle, on which also the towing vehicle-proximal coupling element 6 sits. In the case of a steered trailer 3, a steering movement LB can also be performed on the latter in the stationary state. Overall, such a steering movement LB in the stationary state can be carried out on any steerable towing vehicle axle 2i and/or trailer axle 3k.

For this purpose, the state determination unit 20 in the corrective step STK emits a steering control signal S20f to a towing vehicle steering system 2h and/or a trailer steering system 3i, so as to steer the corresponding steerable vehicle axle(s) 2i, 3k, whereupon a corrective movement BK occurs between the towing vehicle 2 and the trailer 3, or between the two coupling elements 5, 6, respectively. In order to implement a greater corrective movement BK, it can also be provided to align the steerable axles 2i, 3k of the towing vehicle 2 and of the trailer 3 in opposite directions by a corresponding steering movement LB, so that the steering movements LB “work against one another”.

A corrective movement BK between the towing vehicle 2 and the trailer 3 can thus also be caused by this steering movement LB in the stationary state, as a result of which the bracing in the coupling elements 5, 6 is released, and the locked state ZV of the trailer coupling 4 can ideally be adjusted.

In a final verification step STP it can be verified whether the coupling pin 6b, or the coupling claw 6d, respectively, is in the closed position SG after causing the corrective movement BK in the corrective step STK according to at least one of the mentioned embodiments, in that only the position sensor 10a is correspondingly read, for example. However, in the mentioned method steps ST1, ST2, ST2.2, ST2.3, ST2.4, ST3 it can also be plausibly verified again by determining the coupling information KI and the positioning information PI whether the pivotable connection V is correctly configured. It can in this instance be correspondingly emitted as the coupling result KE that a correct pivotable connection Vis configured by way of the trailer coupling 4 with a high probability, as long as the respectively determined items of information KI or KI and PI indicate this.

In principle, the corrective step STK herein can be repeated any number of times, whereby a report that configuring a pivotable connection V is impossible is however emitted to a teleoperator/vehicle driver preferably after the third corrective attempt and/or once a realignment has been caused in the fifth embodiment. In this case, it can be provided that the towing vehicle 2 is positioned in front of the trailer 3, and the parking brake is applied, for example at an actual distance DIst between the coupling elements 5, 6 of between 1 m and 2 m in the case of the drawbar trailer 3a, and of 5 m in the case of a semi-trailer 3b. Should positioning the towing vehicle 2 in front of the trailer not be possible, the towing vehicle 2 can be positioned autonomously next to the trailer 3.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SIGNS (PART OF THE DESCRIPTION)

1 Vehicle
2 Towing vehicle
2a Rear of the towing vehicle 2
2b Towing vehicle drive system
2c Towing vehicle clutch/transmission unit
2d Towing vehicle clutch
2e Towing vehicle brake system
2f Towing vehicle braking means
2g Towing vehicle level control system
2h Towing vehicle steering system
2i Steerable towing vehicle axle
2k Towing vehicle lift axle control
2l Towing vehicle lift axle
3 Trailer
3a Drawbar trailer
3b Semi-trailer
3c Trailer drive system
3d Trailer clutch/transmission unit
3e Trailer clutch
3f Trailer brake system
3g Trailer braking means
3h Trailer level control system
3i Trailer steering system
3k Steerable trailer axle
3l Trailer lift axle control
3m Trailer lift axle
4 Trailer coupling
4a Pin coupling
4b Fifth-wheel coupling
5 Trailer-proximal coupling element
5a Drawbar
5b Eyelet
5c Kingpin
6 Towing vehicle-proximal coupling element
6a Clevis
6b Coupling pin
6c Fifth-wheel plate
6d Coupling claw
7 Electrical activation mechanism
8 Locking mechanism
10 State determination assembly
10a Position sensor
10b Acceleration sensor
10c Speed sensor
10d Wave-based sensor installation
11 Detection range of the wave-based sensor installation
15a Camera
15b LIDAR sensor
15c Radar sensor
15d Ultrasonic sensor
20 State determination unit
a2 Towing vehicle acceleration
a3 Trailer acceleration
AOIst Actual alignment of an object O
A2Ist Actual alignment of the towing vehicle 2
A3Ist Actual alignment of the trailer 3
A5Ist Actual alignment of the trailer-proximal coupling element 5
A6Ist Actual alignment of the towing vehicle-proximal coupling element 6
Brel Relative movement
BK Corrective movement
dH Height difference
DIst Actual distance
DSoll Setpoint distance
F2 Towing vehicle functional unit
F3 Trailer functional unit
j2 Towing vehicle jolt
j3 Trailer jolt
jGW Jolt critical value
jSW Jolt threshold value
KE Coupling result
KI Coupling information
L2 Longitudinal central axis of the towing vehicle 2
L3 Longitudinal central axis of the trailer 3
L5a Longitudinal central axis of the drawbar 5a
LI Items of location information
O Object
POIst Actual position of the object O
P2Ist Actual position of the towing vehicle 2
P3Ist Actual position of the trailer 3
P5Ist Actual position of the trailer-proximal coupling element 5
P6Ist Actual position of the towing vehicle-proximal coupling element 6
PI Positioning information
RG0 Lowest reverse gear
S Position of the locking mechanism 8
S7 Activation signal
S10d Sensor signal
S20a Jolting movement control signal
S20b Release control signal
S20c Height control signal
S20d Brake control signal
S20e Drive control signal
S20g Lift axle control signal
SG Closed position
SO Open position
tV Temporal offset
U Environment
V Pivotable connection
v2 Towing vehicle speed
v3 Trailer speed
VG0 Lowest forward gear
Wist Actual angle
WG Critical angle
Z Coupling state of the trailer coupling 4
ZE Unlocked state of the trailer coupling 4
ZI Status information
ZV Locked state of the trailer coupling 4
STO, ST1, ST2, ST2.1, ST2.2, ST2.3, ST2.4, ST3
Steps of the method for determining the coupling state
STK Corrective step
STP Verification step

1. A method for configuring a pivotable connection between a towing vehicle and a trailer by way of a trailer coupling, wherein configured in a locked state of the trailer coupling is a pivotable connection between a towing vehicle-proximal coupling element on the towing vehicle and a trailer-proximal coupling element on the trailer, the method comprising:
establishing a coupling state of the trailer coupling by at least one item of status information once the towing vehicle has approached the trailer; and
causing a corrective movement such that the trailer and the towing vehicle move relative to one another,
wherein the corrective movement is caused when it cannot, or cannot plausibly, be established by the at least one item of status information whether the locked state of the trailer coupling is present.

2. The method according to claim 1, wherein it cannot, or cannot plausibly, be established by of the at least one item of status information whether the locked state of the trailer coupling is present when the adjustment of the locked state of the trailer coupling is prevented.

3. The method according to claim 1, wherein the corrective movement is automatically caused in that the towing vehicle and/or the trailer are/is at least momentarily set in motion.

4. The method according to claim 1, wherein the corrective movement is caused in that a towing vehicle functional unit disposed in the towing vehicle and/or a trailer functional unit disposed in the trailer are/is automatically actuated,
wherein the towing vehicle functional unit is formed by at least one unit selected from the group comprising:
a towing vehicle drive system, a towing vehicle clutch/transmission unit having a towing vehicle clutch, a towing vehicle brake system having towing vehicle brakes, a towing vehicle level control system, a towing vehicle steering system for steering a steerable towing vehicle axle, and a towing vehicle lift axle control for lifting or lowering a towing vehicle lift axle, and
wherein the trailer functional unit is further formed by at least one unit selected from the group comprising:
a trailer drive system, a trailer clutch/transmission unit having a trailer clutch, a trailer brake system having a trailer brakes, a trailer level control system, a trailer steering system for steering a steerable trailer axle, and a trailer lift axle control for lifting or lowering a trailer lift axle.

5. The method according to claim 4, wherein the corrective movement is caused in that the towing vehicle drive system and/or the trailer drive system are/is actuated by a jolting movement control signal in such that the towing vehicle and/or the trailer are driven in a jolting manner so as to cause a jolting movement of the towing vehicle and/or of the trailer.

6. The method according to claim 5, wherein the towing vehicle clutch/transmission unit and/or the trailer clutch/transmission unit are/is actuated in such that a lowest forward gear or a lowest reverse gear is selected, and the towing vehicle clutch and/or the trailer clutch of the respective clutch/transmission unit are/is simultaneously adjusted to an intermediate position such that the respective clutch is allowed to drag in the lowest forward gear or in the lowest reverse gear.

7. The method according to claim 5, wherein in the presence of the jolting movement control signal, the towing vehicle brake system and/or the trailer brake system are/is also actuated in order to decelerate the towing vehicle and/or the trailer such that the jolting drive of the towing vehicle and/or of the trailer is delimited.

8. The method according to claim 4, wherein the corrective movement is caused in that the towing vehicle brake system and/or the trailer brake system are/is actuated by a release control signal in such that the towing vehicle brakes and/or trailer brakes are released so as to move the towing vehicle and/or the trailer as a function of being inclined or braced.

9. The method according to claim 8, wherein only the towing vehicle brake system is actuated by the release control signal so as to release the towing vehicle brakes, and the trailer brakes in the trailer brake system are applied or remain applied; or
only the trailer brake system is actuated by the release control signal so as to release the trailer brakes, and the towing vehicle brakes in the towing vehicle braking system are applied or remain applied.

10. The method according to claim 8, wherein individual trailer brakes and/or individual towing vehicle brakes are alternatingly released and applied again once or multiple times.

11. The method according to claim 4, wherein the corrective movement is caused in that the towing vehicle level control system and/or the trailer level control system are/is actuated by a height control signal in such that a height difference between the towing vehicle-proximal coupling element and the trailer-proximal coupling element is altered.

12. The method according to claim 4, wherein the corrective movement is caused in that the towing vehicle lift axle control and/or the trailer lift axle control are/is actuated by a lift axle control signal in such that the towing vehicle lift axle and/or the trailer lift axle is lifted or lowered, and a height difference between the towing vehicle-proximal coupling element and the trailer-proximal coupling element is altered as a result.

13. The method according to claim 4, wherein the corrective movement is caused in that the towing vehicle drive system and/or the trailer drive system are/is actuated by a drive control signal in such a manner that the towing vehicle moves away from the trailer so as to newly align the two in relation to one another.

14. The method according to claim 4, wherein the corrective movement is caused in that the towing vehicle steering system and/or the trailer steering system are/is actuated by a steering control signal in such that the corresponding steerable towing vehicle axle and/or steerable trailer axle turns, and the stationary towing vehicle and/or the stationary trailer are/is slightly moved by a steering movement of this type.

15. The method according to claim 1, wherein, upon causing the corrective movement, it is newly established by the at least one item of status information whether the trailer coupling is in the locked state.

16. The method according to claim 15, wherein the towing vehicle drive system and/or the trailer drive system are/is actuated such that the towing vehicle moves away from the trailer, or vice versa, so as to newly align them in relation to one another,

17. The method according to claim 1, wherein the coupling state of the trailer coupling is established by at least two items of status information determined independently of one another, wherein it cannot, or cannot plausibly, be established whether the locked state of the trailer coupling is present when at least one of the items of status information determined independently of one another indicates that the locked state is not present.

18. The method according to claim 17, wherein the coupling state of the trailer couplingis established in at least the following steps:
determining an item of coupling information, wherein the coupling information as is a function of:
a position of a locking mechanism of the trailer coupling and/or
a towing vehicle jolt and/or
a trailer jolt, and
wherein the coupling information indicates whether the trailer coupling could be in the locked state;
determining an item of positioning information, wherein the positioning information as a function of sensor signals of a wave-based sensor installation indicates whether the trailer coupling could be in the locked state; and
determining a coupling result as a function of the coupling information and also as a function of the positioning information, wherein the coupling result indicates whether or not a pivotable connection between the towing vehicle and the trailer by way of the trailer coupling is configured.

19. The method according to claim 18, wherein determination of the positioning information has the comprises:
detecting at least one object in an environment by the wave-based sensor installation and emitting sensor signals, wherein the wave-based sensor installation is disposed on the towing vehicle or the trailer; and
determining an item of location information of the detected object, in particular an actual position and/or an actual alignment of the detected object relative to the wave-based sensor installation or relative to the towing vehicle or the trailer on which the wave-based sensor installation is disposed,
wherein the at least one detected object is the towing vehicle and/or the trailer, or an object connected thereto in the environment which participates in configuring the pivotable connection.

20. The method according to claim 18, wherein the coupling information indicates that the trailer coupling could be in the locked state when it is derived from a movement of the locking mechanism of the trailer coupling and/or from a control signal of an electrical activation mechanism for activating the locking mechanism that the locking mechanism is in a closed position.

21. The method according to claim 18, wherein the towing vehicle jolt and/or the trailer jolt for determining the coupling information are/is determined by:
a speed sensor on the towing vehicle and/or on the trailer, and/or
an acceleration sensor on the towing vehicle and/or on the trailer,
wherein the coupling information indicates that the trailer coupling could be in the locked state (ZV) when the towing vehicle jolt and/or the trailer jolt advise that the trailer-proximal coupling element has contacted the towing vehicle-proximal coupling element, and indicates that the towing vehicle jolt and/or the trailer vehicle jolt have/has reached or exceeded a jolt critical value.

22. The method according to claim 18, wherein the coupling result indicates that the pivotable connection between the towing vehicle and the trailer is configured when the coupling information and also the positioning information indicate that the trailer coupling could be in the locked state.

23. A state determination assembly for configuring a pivotable connection between a towing vehicle and a trailer by way of a trailer coupling according to the method according to claim 1, comprising a state determination unit, wherein the state determination unit is configured to:
establish a coupling state of the trailer coupling by at least one item of status information once the towing vehicle has approached the trailer; and
generate and emit control signals so as to cause a corrective movement in such that the trailer and the towing vehicle move relative to one another, wherein the corrective movement can be caused when it cannot, or cannot plausibly, be established by means of the at least one item of status information whether the locked state of the trailer coupling is present.

24. A commercial vehicle, comprising:
a towing vehicle;
a trailer,
wherein a pivotable connection between a towing vehicle-proximal coupling element on the towing vehicle and a trailer-proximal coupling element on the trailer can be configured by way of a trailer coupling when a locking mechanism of the trailer coupling is moved to a closed position; and
the state determination assembly according to claim 23 for configuring the pivotable connection between the towing vehicle and the trailer by way of the trailer coupling.

25. The vehicle according to claim 24, wherein the trailer coupling is:
embodied as a pin coupling in which an eyelet on a draw bar as the trailer-proximal coupling element, by way of a coupling pin as a locking mechanism is configured to be held in a clevis as the towing vehicle-proximal coupling element so as to configure the pivotable connection, or
embodied as a fifth-wheel coupling in which a kingpin as the trailer-proximal coupling element, by way of a coupling claw as a locking mechanism, is configured to be held on a fifth-wheel plate as the towing vehicle-proximal coupling element so as to configure the pivotable connection.
